(19) United States
(12) Patent Application Publication
(10) Pub. No.: US 2014/0278948 A1
(43) Pub. Date: Sep. 18, 2014

(54) METHODS AND SYSTEMS FOR GENERATING ELECTRONIC DEAL SUMMARY

(71) Applicant: RETAILMENOT, INC., AUSTIN, TX (US)

(72) Inventors: David Jonathan LEMPHERS, Kirkland, WA (US); Shreyas KARNIK, Redmond, WA (US); Christopher COUHAULT, Los Altos, CA (US); Alexandros SUVACIOGLU, Menlo Park, CA (US)

(73) Assignee: RETAILMENOT, INC., AUSTIN, TX (US)

(21) Appl. No.: 13/830,077

(22) Filed: Mar. 14, 2013

(51) Int. Cl. G06Q 30/02

(52) U.S. Cl. CPC G06Q 30/0251
USPC 705/14.49

(57) ABSTRACT

A method for generating online deal summaries. The method can include receiving primary deal content from an affiliate network, recognizing deal data from the received primary deal content using a computer processor, searching for and receiving secondary deal from a resource other than the affiliate network, wherein the secondary deal content includes graphical and textual representations, and generating a detailed deal summary, wherein the detailed deal summary includes the graphical and textual representations from the secondary deal content and deal data from the primary deal content. Accordingly, the method can be used to generate a more visually and engaging experience for consumers using secondary deal content in addition to or replacement of primary deal content.

### FIELD OF THE INVENTION

This invention relates generally to the field of online shopping, data manipulation, and publication of online deals and coupons.

### BACKGROUND

The intrusion of the Internet into everyday life has steadily led to the growth of e-commerce websites that offer consumers the option to shop for products online, rather than from brick-and-mortar retailers. Similar to traditional retailers, online businesses also make use of limited promotions and discount coupons to increase sales and drive consumer traffic to their storefronts.

As online retailers, known as “advertisers” in the industry, expand their use of promotions and discount coupons, the confusing array of online deals, discounts, and coupons has led to the use of aggregator websites to collect and display discounts, coupons, and promotional deals. These aggregator websites, known as “publishers” in the industry, rely on aggregating large assortments of deals and coupons from advertisers to draw web traffic and generate profits. Generally speaking, a “publisher” is any business or individual that prepares, issues and/or delivers content to an audience. In many cases, a publisher acts as a host/medium for content, which often comes from an advertiser. The publisher sites attract users by providing information on a variety of discounts from a variety of advertisers in a single convenient location.

Intermediaries known as “affiliate networks” are membership groups that connect the publishers and the advertisers. They help publishers participate in affiliate programs offered by advertisers and help advertisers promote their affiliate programs to the broad array of publishers within the affiliate network. Content shared within the affiliate network is often delivered in a simple content feed, which is simply a batch of data produced either directly by a retailer or assembled by an affiliate network or network aggregator consisting of deal or coupon content.

Through affiliate networks, advertisers may offer commissions to publishers for posting the advertiser's information about online deals or coupons. An online deal is a promotional offer that generally does not require a promotion code for redemption. An online coupon is a type of online deal that requires a promotion code to be used at checkout in order for the savings to be applied. If the promotion code is not applied, the shopper does not receive any savings.

Commissions for publicizing online deals and coupons can take many forms. In some instances, advertisers may offer a share of the revenue generated from visitors directed to the advertiser by the publisher. Alternatively, advertisers may offer a fee for each visitor on the publisher's site that completes a specific action at the advertiser's site (e.g., making a purchase, registering for a newsletter, etc.). These promotions create a direct financial incentive for publishers to post the advertiser's information, which ultimately results in exposure for the advertiser.

Affiliate networks share advertiser's deal information with publishers through the dissemination of two forms of content: (1) content data and (2) content metadata. Coupon or deal content data comprises textual and/or image information such as banners and advertiser logos, promotional offers, or other information. For example, deal content data may include “Free shipping when you buy any 4 boxes of K-cup portion packs.” Exemplary coupon content data may include “Save 10% Off your next purchase when you use coupon 10OFF at checkout.”

Content metadata can include the corpus information associated with the content, such as a content unique identifier, a content format (e.g., text, pixel size of banner ads), a content status (e.g., whether the content is active or expired), content promotion dates (e.g., the start and end dates when advertisers would like this content to be promoted), and content payout terms (e.g., earnings per 100 traffic clicks (“EPC”)).

Today there are a plurality of affiliate networks from which publishers can access advertiser content. Affiliate networks may differ in one or more of the following ways:
Advertisers that are part of their network;
Quantity of the content and content metadata uploaded to their network by advertisers;
Content and content metadata structure provided (number of fields, length of fields, sequence of fields, mandatory and optional fields for advertisers);
Freshness of the content (date uploaded by advertisers, date made available to publishers);
Reliability of this content (verification performed by the affiliate network to ensure the accuracy of the content, e.g., broken advertiser links);
Technical accessibility of this content (mechanisms and ease of accessing this information, e.g., content programmatically accessed and/or refreshed through an API, API call limits, provision of an XML file, manual access through affiliate website, etc.);
Commission structure (revenue share, action compensation and bonuses from the advertiser for publishers, etc.);
Commission payout terms (timing, format, etc.); and
Uptime of affiliate tracking systems (leakage due to system downtime when affiliated traffic will not be tracked or credited to publisher).

Given the vast amount of content from various affiliate networks, publishers face a choice between consuming and displaying large amounts of content or displaying a carefully curated subset. Choosing the former involves receiving content from sources such as affiliate networks or aggregators and publishing the content verbatim, which frequently results in inferior quality. Displaying a carefully curated subset involves going through the costly process of hand curating the content before publishing it.

Currently, affiliate networks merely transmit advertiser content feeds to publishers, which places the burden of sorting, verifying and curating the data on the publishers. This burden creates a significant optimization challenge for each and every member of the affiliate network. As publishers scale, manual curation of advertiser content becomes costly. As a consequence, most publisher sites merely publish content from the advertiser verbatim, with no sorting, optimizations, or enhancements. Given the volume and growth of advertisers and the content they generate, this situation is unlikely to improve also because affiliate networks have little incentive to verify the quality of the content they receive from advertisers.

Prior art systems that have been directed to the identification of optimal content within a plurality of affiliate networks so far only apply simplistic fixed logic. They do not take into consideration the plurality of affiliate networks or the dynamic nature of affiliate commissions. For example, certain affiliate programs may vary commissions based on the time of the month of the transaction.

Accordingly, there is a need for a method and system that generates online electronic deal summaries in a clear and useful manner. In addition, there is a need for a method and system that selects the promotions that meets the priorities of the publishers, including maximizing commissions from advertisers in the affiliate networks, reducing payout scheduling, and favoring advertisers and affiliate networks with whom the publishers have a good relationship.

### SUMMARY OF INVENTION

According to one embodiment of the invention, a method for preparing a detailed deal summary is provided. In this embodiment, the method includes receiving primary deal content from an affiliate network over a computer network and recognizing deal data from the received primary deal content using a computer processor. The method also includes searching for and receiving secondary deal content over a computer network from a resource other than the affiliate network, wherein the secondary deal content includes graphical and textual representations; and generating a detailed deal summary, wherein the detailed deal summary includes the graphical and textual representations from the secondary deal content and deal data from the primary deal content.

Yet another embodiment of the invention is a computer-readable storage media embodying logic that is operable when executed to perform a series of steps. These steps can include receiving primary deal content from an affiliate network over a computer network; recognizing deal data from the received primary deal content using a computer processor; searching for and receiving secondary deal content over a computer network from a resource other than the affiliate network, wherein the secondary deal content includes graphical and textual representations; and generating a detailed deal summary, wherein the detailed deal summary includes the graphical and textual representations from the secondary deal content and deal data from the primary deal content.

Yet another embodiment of the invention is a method for preparing a detailed deal summary. The method includes receiving deal data from a provider over a computer network and identifying relevant deal information from the deal data using a computer processor. The method also includes searching for and receiving additional deal information over a computer network from a resource other than the provider and generating a detailed deal summary, wherein the detailed deal summary includes graphical and/or textual representations from the additional deal information.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a block diagram showing the communication of a system between an advertiser, an affiliate network, and a publisher.

FIG. 2 is a block diagram showing the communication of the publisher with several affiliate networks;

FIG. 3 is a block diagram that shows greater detail of the publisher 103 from FIG. 1;

FIG. 4 is a flow diagram of a method in accordance with certain embodiments of the disclosed subject matter;

FIG. 5 is a flow diagram illustrating how natural language processing may extract content data from an affiliate network's content feed;

FIG. 6 is a block diagram illustrating how the content from affiliate networks may be organized in a relational database in accordance with certain embodiments of the invention;

FIG. 7 is a block diagram illustrating how the content in FIG. 6 may be re-organized in accordance with certain embodiments of the invention;

FIG. 8 is a flow chart illustrating the flow of data through the publisher 103 of FIG. 1 according to one embodiment of the invention;

FIG. 9 is a flow diagram of a method in accordance with certain embodiments of the disclosed subject matter;

FIG. 10 is an example of published content in accordance with certain embodiments of the invention;

FIG. 11 is a diagram illustrating an example of the ranking logic module 309 from FIG. 3 in accordance with certain embodiments of the invention; and

FIG. 12 is a diagram illustrating an example of the ranking logic module 309 from FIG. 3 in accordance with certain embodiments of the invention.

### DETAILED DESCRIPTION

In practice, the interactions between publishers, advertisers and affiliate networks are invisible to the user. In a typical transaction, users at a publisher's website are shown a variety of online coupons and deals that correspond to various advertisers' websites. By selecting an online deal or coupon using a mouse click or finger press, users are automatically redirected to the appropriate advertiser's website. They may then complete the transaction using the advertiser's website and enjoy the benefit of the online deal from the publisher's website. Hence, the user only experiences the publisher's and the advertiser's websites.

In order to facilitate this user experience, a publisher must accurately sort and organize the advertiser's information on the publisher's website. Publishers, however, can only do so after receiving the advertiser's content data, which typically includes information comprised of text and images such as banners and advertiser logos, promotional offers, and content metadata, such as the content affiliate link to the advertiser. Affiliates also provide information relating to commissions, if any, offered by the advertisers to the publishers. This information, along with the content and content metadata, must be sorted and organized in order to be published on a publisher's website. Once organized the information must be displayed in a visually appealing way to attract visitors.

Accordingly, the present invention can manage the complexity of aggregating, sorting, and organizing the content data and content metadata from a plurality of affiliated networks. Specifically, the present invention can receive advertiser content from a plurality of sources, identify the duplicative information, and rank the duplicative information such that the content that is ultimately published to the consumer meets the priorities of the publisher, including maximizing monetary commission, reducing payout schedules, and favoring affiliate networks and advertisers with the best working relationships with the publisher. In that way, the publisher maximizes the profitability of the advertiser content shared with its consumers and users.

Relatedly, the present invention also can retrieve primary content from deal providers, recognize and organize that content, and then retrieve secondary content, which is additional content data and metadata from any source other than the deal provider, such as additional images or text, that may be used to enhance the publication of the primary content. In that way, the publishers may increase the visual appeal of the published content and improve user interactivity through use of reviews, search terms etc.

FIG. 1 shows a system for use in performing some embodiments of the invention. For illustration, FIG. 1 is a simplified block diagram of the communication between a single advertiser 101, a single affiliate network 102, and a single publisher 103. In other embodiments, multiple advertisers 101, multiple affiliate networks 102, and multiple publishers 103 can be used. In order to gain access to advertiser content, the publisher 103 must typically sign up and access content shared in the affiliate network 102. This is shown as step 1 in FIG. 1. The advertiser 101 is typically responsible for supplying content to the affiliate network 102 that may then be shared with the publisher 103. Step 2 in FIG. 1 shows an advertiser 101 supplying content to the affiliate network 102.

When a user on the publisher's site clicks on an advertised online coupon or deal, the traffic is targeted back to the advertiser 101 using a content affiliate link, which can track the activity. FIG. 1 shows the publisher 103 targeting traffic to the advertiser 101 in step 3. A content affiliate link, often in HTML and Javascript, enables a publisher 103 to direct traffic to the advertiser 101 and make money from such traffic referrals. Based on the activity recorded by the content affiliate link, affiliate commissions can be sent from the advertiser 101 to the affiliate network 102 and to the publisher 103. This is shown in step 4 of FIG. 1. In this way, a publisher 103 may get financial compensation for redirecting traffic to one or more advertisers 101.

FIG. 2 shows a block diagram illustrating the content relationships between affiliate networks, a single publisher, and a publisher's users. In some embodiments, affiliate networks share advertiser content through content feeds 201-1 through 201-3 to publisher 202. The publisher 202 bears the responsibility for aggregating, sorting, and organizing the content for its users, represented by block 203. Given the complexity in collecting content (in the form of content feeds exemplified as blocks 201-1 through 201-3), many publishers merely publish the feeds (201-1 through 201-3) verbatim or opt to rely and publish only a single feed from a single affiliate network.

FIG. 3 is a block diagram that shows greater detail of publisher 103 from FIG. 1. At a high level, publisher 103 may be a computer system, comprising computer servers and/or a computer network for sending and receiving data from affiliate networks 102 and redirecting online traffic to the advertisers 101. The publisher 103 can, of course, operate one or more websites or accessible content locations that allow end users to interact with the system to receive deal and/or coupon information. According to an embodiment of the invention, the publisher 103 can communicate and receive content from the affiliate networks, redirect targeted traffic to the advertiser 101, and receive financial commission information from the affiliate networks 102 and advertisers 101. As a computer system, publisher 103 can include, for example, a processor 301, an input/output component 302, and a memory/storage module 303 that comprises the logic modules for operation of the system as a whole. Within the memory/storage module 303 can be several modules, including the content receiving module 304, database storage module 305, relationship analyzer module 306, content identifier module 307, content verification module 308, ranking logic module 309. In some embodiments of the invention, logic, instructions, and data reside in the memory/storage module 303, as described in further detail below. When executed, the logic and instructions in the memory/storage module 303 can perform the operations and functions described herein.

Processor 301 can be configured as a central processing unit or application processing unit in the publisher system 103 from FIG. 1. Processor 301 might also be implemented in hardware using an application specific integrated circuit (ASIC), programmable logic array (PLA), field programmable gate array (FPGA), or any other integrated circuit or circuit structure that can perform the functionality of the publisher system 103 from FIG. 1.

Input/output component 302 may comprise a specialized combination of circuitry (such as ports, interfaces, wireless antennas) and software (such as drivers) capable of handling the receiving and/or transmitting of deal data or other information from affiliate network systems (e.g., 102 from FIG. 1).

Memory/storage module 303 can be cache memory, flash memory, a magnetic disk drive, an optical drive, a programmable read-only memory (PROM), a read-only memory (ROM), or any other memory or combination of memories. The memory/storage module 303, therefore, can be a non-transitory computer readable medium of a variety of types known to those skilled in the art.

Within memory/storage module 303, the content receiving module 304 comprises logic modules for receiving digital content data and metadata from primary sources (e.g., affiliate networks) and secondary sources (e.g., third parties). When executed, the logic and instructions on the content receiving module 304 perform the operations described herein. The content receiving module 304 can be configured to handle the incoming content data and metadata from affiliate networks 102 and third parties. It can be configured to connect publisher 103 to affiliate networks 102, send login information to affiliate networks 102, and receive digital content from affiliate networks 102. In some embodiments, the content receiving module 304 may also be configured to receive information relating to commissions from affiliate networks 102 and advertisers 101 based on traffic from content affiliate links. In some embodiments, the content receiving module 304 may also be configured to receive secondary content data and metadata, such as images, specifications, and reviews, from at least one third party.

The database storage module 305 can be configured to provide temporary and permanent storage for digital content data and metadata prior to publication. This may include storage of content data and metadata in separate entries as part of a relational, hierarchical, or network database. In some embodiments, the database storage module 305 may be configured to store primary content data from affiliate networks 102 and secondary content data from third parties.

The relationship analyzer module 306 can be configured to determine the relationships between the advertisers 101 and affiliate networks 102. This may involve cross-referencing advertisers 101 across different entries in the database storage module 305. In some embodiments, the relationship analyzer logic module 306 may also use processor 301 to verify that an affiliate relationship exists by comparing the data in the database storage module 305 with the list of affiliate networks 102 in the relationship analyzer module 306.

The content identifier module 307 can be configured to normalize and tag each deal using a unique identifier. The unique identifier may be a hash code identifier, which is a key generated for each coupon and deal. For coupons, the hash identifier may be generated using the advertiser domain and the voucher code. For deals, the hash identifier may be generated using the advertiser domain and deal title. Substantially duplicate hash identifiers exist when multiple coupons or deals with identical content data are found.

The content verification module 308 can be configured to verify, for each coupon and deal, if the original content affiliate link provided by the affiliate network 102 is supported by the particular advertiser 101. In some embodiments, if the original content affiliate link is not supported by the affiliate network 102, the content verification module 308 may replace the original content affiliate link with an affiliate “catch-all” link. An affiliate “catch-all” link is a content affiliate link that is not associated with a particular deal or coupon, but is instead affiliated with the advertiser 101 as a whole. When the affiliate “catch-all” link is activated, the advertiser 101 will recognize that the traffic was redirected from the publisher 103. Thus, users who select the deal and are redirected using the affiliate “catch-all” link will not receive an error message; and the publisher will still receive credit (and a commission) for directing users to the advertiser. Additionally, an affiliate “catch-all” link may also be substituted if it is determined that a deal or coupon is valid outside the provided start and end dates that the advertiser 101 provided, and/or is valid on other areas of the advertisers' site.

The ranking logic module 309 can be configured to rank the deals and coupons based on the priorities of the publisher. In some embodiments, the ranking logic module 309 may be configured to identify hash identifiers and rank the content affiliate links based on revenue generation. For example, the ranking logic module 309 may rank a content affiliate link with a 20% commission higher than a content affiliate link with a 10% commission. In some embodiments, the ranking logic module 309 considers payout schedules and the general working relationship between the publisher 103, affiliate network 102, and advertiser 101. For example, the ranking logic module 309 may apply a negative, punitive score to a content affiliate link if the average payout for the associated affiliate network exceeds 30 days. Similarly, the ranking logic module 309 may apply a comparative score ranking to the affiliate networks based on payout scheduling. In some embodiments, the entries based on non-optimum hash identifiers and their associated deals or coupons are discarded.

The secondary content analyzer 310 may be configured to analyze the content in the database storage module 305 for “missing” secondary content from third parties, which may include images, reviews, and/or specifications of the advertiser's products and retail operations. Additional types of secondary content can also be used. Secondary content is important because it increases user interaction with the published advertisement by enhancing the visual appearance of online deals and coupons as well as providing information that improves user engagement, such as reviews and related search terms. The secondary content analyzer 310 may also be configured to coordinate communicating, accessing, and retrieving secondary content from third parties prior to publication, and storing that content in the database storage module 305.

The publishing logic module 311 may be configured to organize and publish the content data, i.e., text, images and content affiliate links, in the database storage module 305. In some embodiments, this may involve publishing the information on a website, an online newsletter, a mobile or computer software application, or a browser-based application.

FIG. 4 is a flow chart illustrating the operation of one embodiment of the invention. In this embodiment, the actions described below (for example, in connection with FIG. 4) can be performed by the publisher system 103 or through a system affiliated with the publisher 103. At a high level, the embodiment of FIG. 4 programmatically determines an optimal link for the publisher 103 to select in order to maximize a return to the publisher 103. The return that is maximized can be, for instance, a commission or a relationship with an affiliate network 102. The system can pull large amounts of data from a plurality of affiliate programs; the data can include, for example, content, content link, content metadata, advertiser payout rules, etc. . . . . The system can then unify and cleanse the data to make it comparable across a plurality of dimensions. Finally, the system can rank and select the most optimal content, content link, and affiliate program to maximize a commission, reduce payout scheduling, or favor advertisers and affiliate networks with whom the publisher has the best working relationship. This can be performed on a per content and/or per advertiser basis and could, for example, result in content number 3 with link number 2 and affiliate program D.

Start block 401 of FIG. 4 can be initiated by the activation of the publisher 103. In some embodiments, this may be initiated by the initialization of a connection to the affiliate network systems. The initialization may come as a particular set of instructions exposed through technology interfaces, such as software or hardware. The connection may occur through a variety of mediums, such as a web interface, mobile interface, wire protocol, or shared data store such as a queue or similar construct. The connection may occur through software or hardware, so it can be language independent, and may be initiated directly through a standardized interface or via a proprietary protocol from a software development kit or bundled set of libraries. The connection may be provided directly by the affiliate network 102 or through a third party, such as a hosting provider or software vendor. In some embodiments, the connection may be through an affiliate aggregator, which is a third party that does not have a direct relationship with any advertisers 101, but instead acts as another level of intermediary by aggregating deals across different affiliate networks 102. Affiliate aggregators may have a large mix of duplicate content while providing, in most cases, a better percentage of advertiser coverage.

In some embodiments, the initialization comprises using login information to access the deal provider's (i.e. affiliate network's) system. The login process may proceed using a variety of methods, such as through manual input, programmatically through an application protocol interface (API), or other electronic methods.

In block 402 of FIG. 4, the publisher 103 may receive content data and metadata from the affiliate networks 102 and/or affiliate aggregators. For example, raw content from an affiliate network may be the output of a feed:
$5 off Fisher-Price Poppity Pop Musical Dino @Target.com using coupon code TGT4QRQP between 15 Dec. 2015-15 Mar. 2015

This step can be managed through a combination of the input/output component 302 and the content receiving module 304 of FIG. 3. The content may be stored in a database storage module 305 prior to sorting and organization. In some embodiments, this process is automated using the processor 301, input/output component 302, and content receiving logic module 304. In some embodiments, the content data and metadata may be communicated in the form of a text or image feed.

Referring again to FIG. 4, in block 403, the publisher 103 can determine the relationships between the advertisers 101 and affiliate networks 102 based on received content. This step will verify that use of the content, i.e., the affiliate content link, will result in a commission from the affiliate network and advertiser. This step may be managed through a combination of the processor 301 executing instructions from the relationship analyzer logic module 306 of FIG. 3. The resulting analysis may be stored in the database storage module 305.

In some embodiments, the relationship analyzer logic module 306 may also verify that an affiliate relationship exists. An affiliate relationship can be, for instance, an approved, mutual relationship between a publisher 103 and an affiliate network 102. If the relationship is not approved, any shared content affiliate link is non-functional and likely provides no revenue to the publisher 103 (which is not desirable for the publisher 103). This step can be managed by comparing the data in the database storage module 305 with the relationship analyzer module 306 using processor 301.

In block 404 of FIG. 4, the publisher 103 can normalize and tag each deal content using a unique identifier, also referred to as “cleansing” the content. This step is managed through a combination of the processor 301 executing instructions from the content identifier logic module 307 of FIG. 3. In some embodiments, this identifier may be a hash code identifier. A hash code identifier is a key generated for each coupon and deal. With respect to coupons, the hash identifier may be generated using the advertiser domain and the voucher code. With respect to deals, the hash identifier may be generated using the advertiser domain and deal title.

For illustrative purposes, consider the earlier example of raw content data from a content feed from an affiliate:
$5 off Fisher-Price Poppity Pop Musical Dino @Target.com using coupon code TGT4QRQP between 15 Dec. 2015-15 Mar. 2015

Using textual analysis, parsing, and manipulation, the cleansed content in the database may be configured in this way, using separate entries all linked to the same hash identifier (“_id”):

```
{
  “_id”: “511cd5b0b47a9a5059fcce49”,
  “title”: “$5 off Fisher-Price Poppity Pop Musical Dino @Target using
coupon code TGT4QRQP.”,
  “description”: “$5 off Fisher-Price Poppity Pop Musical Dino @Target
using coupon code TGT4QRQP.”,
  “start_date”: “2015-02-15T02:21:09”,
  “end_date”: “2015-03-15T02:21:09”,
  “expired”: false,
  “merchant_name”: “Target”,
  “merchant_url”: “www.target.com”,
  “source”: “xyzfeeds”,
  “type”: “coupon”,
  “voucher_code”: “TGT4QRQP”
}
```

In some embodiments, this step may be performed using natural language processing. FIG. 5 is a flow diagram illustrating how natural language processing may extract content data from an affiliate network's content feed. Step 501 represents the content data as received by the publisher from the affiliate network. Step 502 subsequently follows after the publisher uses natural language processing to extract the expiration dates. Step 503 follows after extracting the coupon code and other information such as the merchant name. After the product and offer information is loaded into the database, in step 504, they are retained as the title for the content for publication to the consumers.

FIG. 6 is a block diagram illustrating how the content from network affiliates may be organized in a relational database in accordance with certain embodiments of the invention. Once normalized and cleansed, each entry of content, shown as blocks 601, 602, and 603, may be linked relationally to their associated content affiliate link and content metadata in database storage module 205, pictured in FIG. 6 as rows.

Returning to FIG. 4, in block 405 the content verification logic module 308 can verify, for each coupon and deal, if the original content affiliate link provided by the affiliate network system is supported by the particular advertiser 101. In some embodiments, this may be performed by reviewing the expiration dates from the content feed or applying the coupon on the advertiser's website to see if the coupon is accepted. In some embodiments, if the coupon or deal is not valid, the original content affiliate link can be replaced with an affiliate “catch-all” link, which is a content affiliate link that is not associated with a particular deal or coupon, but is instead associated with the advertiser 101 as a whole.

In block 406 of FIG. 4, the publisher system may be configured to rank the duplicative (from a consumer's perspective) deals and coupons based on the strongest working relationship with deal providers. For example, the deal content can be analyzed to determine that at least one deal is represented by deal content from at least two deal providers or advertisers. Two providers, for instance, could offer the same deal or coupon for a pair of Nike running shoes. In this example, the deal is identified as being substantially duplicative despite being represented by different sets of deal content from different affiliates. In some embodiments, deals may be substantially duplicative due to their similarities of advertiser discounts and offers, despite having different deal content data or metadata. This step can be managed through the processor 301 executing instructions from the ranking logic module 309. In some embodiments, the ranking logic module 309 determines identical hash identifiers and ranks the content affiliate links based on revenue generation.

In some embodiments, the ranking orders the deal content data and metadata according to the greatest monetary commission. For example, the ranking logic module 309 may rank a content affiliate link with a 20% commission higher than a content affiliate link with a 10% commission. In some embodiments, the ranking logic module 309 considers payout schedules and the general working relationship between the publisher 103, affiliate network 102, and advertiser 101. For example, the ranking logic module 309 may apply a negative, punitive score to a content affiliate link if the average payout for the associated affiliate network exceeds 30 days. Similarly, the ranking logic module 309 can be configured to apply a comparative score ranking to the affiliate networks based on payout scheduling. In some embodiments, the entries based on non-optimum hash identifiers and their associated deals or coupons are discarded. In some embodiments, the ranking results are organized in a hierarchy.

FIG. 11 illustrates one example showing how the ranking logic module 309 may be configured to manage duplicative deals and promotions based on monetary commission according to one embodiment. As shown in block 1100, the publisher may be configured to receive content relating to the same promotion (“1”) from the same advertiser (“X”) from three different deal providers (“A”, “B”, “C”), which may return commissions at different rates. In response, as shown in block 1101, the ranking logic module 309 may be configured to publish only the content relating to the 7% commission. In this way, the publisher will get the highest commission (7%) from redirecting users interested in that promotion.

In some embodiments, the publisher system determines appropriate deal content from substantially duplicative deals by executing a decision tree that takes into consideration the resulting monetary commission, resulting revenue, as well as payout schedules and the general working relationship between the publisher 103, affiliate network 102, and advertiser 101. Using the decision tree, the optimum content data and metadata may be identified based on the publisher customized priorities.

In some embodiments, the publisher system may be configured to replace the content of deals where the advertiser, and not the deal itself, is duplicative. FIG. 12 shows an illustration of such an embodiment. As shown in block 1200, the publisher may be configured to receive different promotions (“1”, “2,” “3”) from the same advertiser (“X”) from different deal providers (“A,” “B,” “C”), which may return commissions at different rates. In response, as shown in block 1201, the ranking logic module 309 may be configured to publish all of the promotions (“1”, “2,” “3”) using the content data and metadata, e.g., including the affiliate content link, relating to the 7% commission. In this way, the publisher will get the highest commission (7%) from redirecting users interested in any of the promotions (“1”, “2,” “3”). In other embodiments, the deal content can be organized for the plurality of deals based on a priority of the publisher. This priority can factor in one or more of a monetary commission resulting from the use of the content affiliate link, a payout schedule related to the monetary commission, and a working relationship with the deal provider. To weigh these comparative priorities, some embodiments may use a weighted scoring system to adjust the comparative desirability of the deal content to the publisher. For example, a high commission may result in a high positive score, a long payout delay may reduce that score, while a good working relationship may improve the score.

FIG. 7 is a block diagram illustrating how the content in FIG. 6 may be re-organized in accordance with certain embodiments of the invention. In some embodiments of the invention, ranking logic module 309 may amend the relational database in database storage module 305 to exclude less profitable affiliate content links (block 603) for more profitable ones (block 602). In some embodiments, the affiliate content links and content metadata originally associated with block 603 may be discarded now that they are unused.

In block 407 of FIG. 4, having completed the ranking of the hash identifiers, the publisher system 103 has completed its online coupon and deal database in database storage module 305 and the process is complete. With the online coupon and deal database complete, the publisher 103 may publish the information on its website.

FIG. 8 is a flow chart illustrating the flow of data through the publisher 103 of FIG. 1 according to one embodiment of the invention. As with blocks 201-1, 201-2, and 201-3 of FIG. 2, blocks 801-1, 801-2, and 801-3 are representative of advertiser content feeds from different affiliate networks to an individual publisher. That individual publisher programmatically retrieves the raw content in step 802, akin to step 402 in FIG. 4. In step 803, the data is normalized prior to storage, akin to step 404 in FIG. 4. In step 804, the normalized content may be stored in a storage module, such as database storage module 305. In step 805, the content in database storage module 305 may be organized into an advertiser matrix in order to a facilitate publication of the content on a website.

As explained above, the majority of content generated for deals tends to be of a low quality and is not as useful for human consumption as it could be. There are multiple sources of deal content for publishers to utilize, but because the content is generally mass produced it suffers from a number of inadequacies, including:
Inaccurate product descriptions (i.e., naming a product for which the deal is not applicable),
Limited product descriptions (i.e., specifying a deal for Canon cameras, when it may only pertain to limited models),
Inaccurate deal descriptions (i.e., specifying an incorrect or misleading level of savings),
Limited content (i.e., lack of multimedia or user-generated content like reviews and ratings),
Duplicate content (i.e., multiple sources restating the same deal with slightly different wording leading to duplicate content),
Unrelated or misplaced content (i.e., URLs in place of titles and descriptions, placeholder text left in place, etc.),
Inaccurate information regarding validity (i.e., displaying an incorrect expiration date), and
Inaccurate content affiliate link (i.e., broken or misdirected URLs).

FIG. 9 is a flow chart illustrating the operation of a different embodiment of the invention. At a high level, the system and method of FIG. 9 can be used to generate a detailed deal summary, and the method can be performed by the publisher 103. In short, this can be done by pulling in the initial content from multiple sources including feeds directly from affiliate programs or retailers themselves, processing the content to remove low quality content, assessing the content and finding other sources of reviews for the content, images, specifications, and additional information, and then publishing the information to consumers or third parties.

As an example, if a deal relates to a pair of Nike running shoes, but provides only high level information, such as “10% off Nike Pegasus shoes,” the system and method described herein can generate a more detailed deal summary. It can do so by searching for multiple sources of the same deal, processing this content, and then finding additional content. For example, the additional content can include images of the Nike Pegasus shows, links to more detailed information about the shoes, and more detailed information about the shoes.

In FIG. 9, start block 901 can be initiated by the completion of the online coupon and deal database, corresponding to block 407 of FIG. 4. In block 902, the processor 301 may analyze the content in the database storage module 305 for “missing” secondary content using instructions from the secondary content analyzer 310. As discussed with respect to block 404 of FIG. 4, this search for “missing” content may apply natural language processing shown in FIG. 5. “Missing” secondary content may include images, reviews, and specifications of the advertiser's products and retail operations. This data may be used to enhance the visual appearance of online deals and coupons upon publication in step 904. Additionally, secondary content may be used to improve user interactivity and engagement through user reviews, feedback, and related search terms. Secondary content may also be used to replace primary content when applicable.

In block 903, the publisher 103 may reach out to third parties for “missing” secondary content, such as images, reviews and specifications. This step may be coordinated by the secondary content analyzer 310 and the receiving content module 304 of FIG. 3, and executed by the input/output component 302 and processor 301. Secondary content retrieved may be stored in the appropriate entries in the database storage module 105.

Generally, the publisher 103 can use keywords about the deal to automatically search for secondary content data regarding the deal. The publisher 103 can search, for example, websites relating to the maker of the product at issue for the deal or websites with reviews of products. The publisher 103 can then recognize that the data found from these searches relates to a specific deal. The secondary content data can include, for example, graphical and textual representations of the deal.

For illustrative purposes, consider the earlier example of raw content data from a content feed from an affiliate:
$5 off Fisher-Price Poppity Pop Musical Dino @Target.com using coupon code TGT4QRQP between 15 Dec. 2015-15 Mar. 2015

As discussed with respect to block 404 of FIG. 4, using textual analysis, parsing, and manipulation, the cleansed content in the database may be configured in this way, using separate entries all linked to the same hash identifier (“_id”):

```
{
  “_id”: “511cd5b0b47a9a5059fcce49”,
  “title”: “$5 off Fisher-Price Poppity Pop Musical Dino @Target using
coupon code TGT4QRQP.”,
  “description”: “$5 off Fisher-Price Poppity Pop Musical Dino @Target
using coupon code TGT4QRQP.”,
  “start_date”: “2015-02-15T02:21:09”,
  “end_date”: “2015-03-15T02:21:09”,
  “expired”: false,
  “merchant_name”: “Target”,
  “merchant_url”: “www.target.com”,
  “source”: “xyzfeeds”,
  “type”: “coupon”,
  “voucher_code”: “TGT4QRQP”
}
```

Secondary content may include, for example, images and reviews of the “Fisher-Price Poppity Pop Musical Dino.” The secondary content analyzer 310 may then search the web for images and reviews of the item. The secondary content analyzer may search, for example, the advertiser Target.com for both related images and reviews. Alternatively, the secondary content analyzer may search Google or Amazon or other websites for the same secondary content. Using secondary data, the content may be embellished with some of these details, such as reviews (“staff_pick”) and related terms (“keywords”) prior to publication:

```
{
  “_id”: “511cd5b0b47a9a5059fcce49”,
  “title”: “$5 off Fisher-Price Poppity Pop Musical Dino @Target using
coupon code TGT4QRQP.”,
  “clean_title”: “$5 Off Fisher-Price Poppity Pop Musical Dino ”,
  “description”: “$5 off Fisher-Price Poppity Pop Musical Dino @Target
using coupon code TGT4QRQP.”,
  “start_date”: “2015-02-15T02:21:09”,
  “end_date”: “2015-03-15T02:21:09”,
  “expired”: false,
  “merchant_name”: “Target”,
  “merchant_url”: “www.target.com”,
  “source”: “xyzfeeds”,
  “staff_pick”: false,
  “type”: “coupon”,
  “voucher code”: “TGT4QRQP”,
  “offer”: “$1 off”,
  “product”: “ Fisher-Price Poppity Pop Musical Dino”,
  “keywords”: “fisher-price, dino, dinosaur, target”
}
```

In block 904 of FIG. 9, the processor 301 may organize and publish the content data, i.e. text, images and links, in the database storage module 305 using instructions from the publishing logic module 311. In some embodiments, this may involve publishing the information on a website, an online newsletter, a mobile or computer software application, or a browser-based application. Once published, the process is complete because the deal and coupon content from advertisers has been organized and cleansed, and is now viewable by consumers and third parties.

FIG. 10 of is an example of published content in accordance with certain embodiments of the invention. As discussed with respect to block 404 in FIG. 4 and block 903 in FIG. 9, the title and merchant name as shown by items 1001 may be analyzed and parsed from the textual content received from the affiliate network's content feed. As discussed with respect to block 903, secondary content such as images (relating to the vendor) may be retrieved by the secondary content analyzer 310 and used by the publisher to enhance the visual appearance of the coupon or deal. Finally, as discussed with respect to block 405 in FIG. 4, the coupon or deal may be verified and a visual indicator (e.g., tag or label) may be shown if valid.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways. Also, it is to be understood that the phraseology and terminology employed herein are for the purpose of description and should not be regarded as limiting.

What is claimed is:

1. A method for preparing a detailed deal summary, comprising:
(a) receiving primary deal content from an affiliate network over a computer network;
(b) recognizing deal data from the received primary deal content using a computer processor;
(c) searching for and receiving secondary deal content over a computer network from a resource other than the affiliate network, wherein the secondary deal content includes graphical and textual representations; and
(d) generating a detailed deal summary, wherein the detailed deal summary includes the graphical and textual representations from the secondary deal content and deal data from the primary deal content.

2. The method of claim 1, wherein at least one of the primary deal content and secondary deal content comprises promotion code information, and wherein the detailed deal summary is an electronic coupon.

3. The method of claim 2, further comprising displaying the electronic coupon on an output display.

4. The method of claim 2, wherein at least one of the primary deal content and secondary deal content comprises at least one of item information, discount information, price information, expiration information, or link information.

5. The method of claim 2, wherein the electronic coupon comprises at least one of affiliate network information, advertiser information, item information, discount information, price information, expiration information, or link information.

6. The method of claim 1, wherein the resource is an online storage device accessed over a computer network.

7. The method of claim 1, wherein the secondary deal content comprises images related to at least one of an affiliate network, an item, or an advertiser.

8. The method of claim 1, wherein the secondary deal content comprises reviews related to at least one of an affiliate network, an item, or an advertiser.

9. The method of claim 1, further comprising:
(a) storing the primary deal content in a database; and
(b) adding the secondary deal content to the database.

10. The method of claim 9, wherein generating the detailed deal summary comprises retrieving the secondary deal content from the database.

11. A non-transitory computer readable medium having executable instructions that, when executed by a processor, are operable to cause an apparatus to:
(a) receive primary deal content from an affiliate network over a computer network;
(b) recognize deal data from the received primary deal content using a computer processor;
(c) search for and receiving secondary deal content over a computer network from a resource other than the affiliate network, wherein the secondary deal content includes graphical and textual representations; and
(d) generate a detailed deal summary, wherein the detailed deal summary includes the graphical and textual representations from the secondary deal content and deal data from the primary deal content.

12. The non-transitory computer readable medium of claim 11, wherein at least one of the primary deal content and secondary deal content comprises promotion code information, and wherein the detailed deal summary is an electronic coupon.

13. The non-transitory computer readable medium of claim 12, wherein the executable instructions are further operable to cause the apparatus to display the electronic coupon on an output display.

14. The non-transitory computer readable medium of claim 12, wherein at least one of the primary deal content and secondary deal content comprises at least one of item information, discount information, price information, expiration information, or link information.

15. The non-transitory computer readable medium of claim 12, wherein the electronic coupon comprises at least one of affiliate network information, advertiser information, item information, discount information, price information, expiration information, or link information.

16. The non-transitory computer readable medium of claim 11, wherein the resource is an online storage device accessed over a computer network.

17. The non-transitory computer readable medium of claim 11, wherein the secondary deal content comprises images related to at least one of an affiliate network, an item, or an advertiser.

18. The non-transitory computer readable medium of claim 11, wherein the secondary deal content comprises reviews related to at least one of an affiliate network, an item, and an advertiser.

19. The non-transitory computer readable medium of claim 11, wherein the executable instructions are further operable to cause the apparatus to:
(a) store the primary deal content in a database; and
(b) add the secondary deal content to the database.

20. A method for preparing a detailed deal summary, comprising:
(a) receiving deal data from a provider over a computer network;
(b) identifying relevant deal information from the deal data using a computer processor;
(c) searching for and receiving additional deal information over a computer network from a resource other than the provider; and
(d) generating a detailed deal summary, wherein the detailed deal summary includes graphical and textual representations from the additional deal information.
